(19) United States
(12) Patent Application Publication
(10) Pub. No.: US 2002/0133830 A1
(43) Pub. Date: Sep. 19, 2002

(54) Adaptive video on-demand system and method using tempo-differential file transfer

(75) Inventors: Roger Y. Kim, Herdon, VA (US); Bob M. Bernstein, Annandale, VA (US)

Correspondence Address: FLESHNER & KIM, LLP, P.O. Box 221200, Chantilly, VA, 20153-1200, US

(73) Assignee: Artista Communications, Inc.

(21) Appl. No.: 09/828,582

(22) Filed: Jun. 28, 2001

Related U.S. Application Data
(60) Provisional application No. 60/259,872, filed on Jan. 8, 2001.

(51) Int. Cl. H04N 7/16; H04N 7/025; H04N 7/10

(52) U.S. Cl. 725/142; 725/34; 725/146

(57) ABSTRACT

A video-on-demand (VOD) system is disclosed and method for providing a real-time VOD experience using Tempo-Differential file transfer with various buffering techniques and an adaptive file distribution system. The system is configured to populate users' Set-Top-Boxes (STBs) with a set of videos which correspond to the individual user's preferences, and populates a Central Office Storage (COS) server with a larger set of videos based on an analysis of all of the users' preferences. The system thus provides a real time VOD service by either correctly predicting the videos that a user will request and preloading them onto that user's STB, or by delivering the requested video from the COS to the STB using a Tempo-Differential file transfer which delays the playing of the requested video while video trailers or other information is displayed on the video screen. When using a DSL connection to the COS, only a portion of the requested video needs to be buffered on the STB before the requested video begins playing. Accordingly, by predicting which videos a user will request and by using the Temp-Differential file transfer, a real time VOD experience is achieved.

Priority of Provisional Application Serial No. 60/259,872, filed on Jan. 8, 2001 is claimed under 35 U.S.C. 119(e), the entire disclosure of which is incorporated herein by reference.

### BACKGROUND OF THE INVENTION

1. Field of the Invention

The present invention relates to a video-on-demand system, and more particularly to a video-on-demand system capable of providing a real-time video-on-demand experience using Tempo-Differential file transfer using buffering techniques, and an Adaptive File Distribution System.

2. Background of the Related Art

A related art video-on-demand system typically includes a user terminal and a remote video server. The remote video server is typically located within a cable company facility or a Central Office. The user terminal is configured to control a video selection process. It includes a communication unit, a memory, and a video signal decoder. A user selects a desired video by inputting commands for looking up and selecting the video. The communication unit then exchanges data with the remote video server through a communications network, such as a cable system or the Internet, and receives coded data of the selected video. The coded data delivered from the server is either buffered or stored in the terminal memory to be decoded by the video signal decoder for immediate viewing.

In the related art video-on-demand system, when a user requests a video, the remote video server receives the request and must then access the desired video from remote memory. Then the remote server retrieves the requested video data and begins delivery to the user. The video data received by the user is stored in the terminal memory and video signals are reproduced by the video signal decoder from the coded data.

In this sense, the related art video-on-demand server is essentially a remote video recorder on which a selected video is played back. The related art video-on-demand environment requires the use of large capacity data storage devices that send or “stream” requested videos to users on an “as selected” basis. That is, video data is transferred to the user only when a particular video is selected. Accordingly, the server must store a large number of videos to accommodate the preferences of a wide variety of users, and must always maintain enough bandwidth to deliver the videos to the users in real time.

The related art video-on-demand systems deliver video streams directly from the head-end video processors. Accordingly, the related art systems are bandwidth and video processor intensive at the video head-end. The video-on-demand systems require massive computing power for the interactive delivery of video information to the users. Additionally, a high bandwidth for channel downstream, and at least a low bandwidth upstream channel, are required to allow a user to interact with the remote video server to control video delivery options, such as video selection or other programming options. Accordingly, the related art video-on-demand system is inefficient, expensive, and a non-scalable true realtime video-on-demand experience.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

It is an object of the present invention to provide a video-on-demand system and method that substantially obviates problems caused by disadvantages in the related art.

It is another object of the present invention to provide a video-on-demand system and method that substantially obviates problems due to limitations in the related art.

It is another object of the present invention to provide a real-time video-on-demand system and method over a broadband network infrastructure, or an Internet infrastructure with guaranteed bandwidth.

It is another object of the present invention to provide a real-time video-on-demand system and method to Digital Subscriber Line (DSL) customers.

It is another object of the present invention to provide a cost effective and scalable video-on-demand system and method using an integrated delivery solution.

It is another object of the present invention to provide a video-on-demand system and method that uses an integrated hierarchical network design and adaptive file transfer features.

It is another object of the present invention to provide a video-on-demand system and method that uses Tempo Differential file transfer design to achieve real-time video-on-demand.

It is another object of the present invention to provide a hierarchical real-time video-on-demand system and method using a Set-top box (STB), Central Office Storage (COS), and a Video Warehouse (VW), which are communicatively coupled.

In order to achieve at least these objects in whole or in parts, there is provided a method of transferring MPEG files on demand, maintaining a first set of MPEG data on at least one COS device, pushing a plurality of second sets of data from the at least one COS device to a corresponding plurality of STBs in accordance with a plurality of user profiles, and pushing a plurality of third sets of data from at least one COS device to corresponding ones of the plurality of STBs in accordance with the plurality of user profiles, wherein the first set of data comprises data that is likely to be requested by the plurality of STBs, and wherein the second and third sets of data comprise data that is likely to be requested by a corresponding one of the plurality of STBs.

In order to further achieve at least these objects in whole or in parts, there is provided a data on demand file transfer system, comprising, at least one set top box (STB), configured to maintain a list of available data and store a first prescribed portion of the available data, at least one Central Office Storage and processing device (COS), communicatively coupled to at least one STB, and configured to store a second prescribed portion of the available data and maintain a database of activity of at least one STB, and a main storage facility, communicatively coupled with at least one COS, configured to store all of the available data, wherein the first and second prescribed portions of the available data are selected based on at least one of user and community interest profiles.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a drawing illustrating a video-on-demand (VOD) Network Architecture, according to a preferred embodiment of the present invention.

FIG. 2 is a drawing illustrating an adaptive VOD File Control System, according to a preferred embodiment of the present invention.

FIG. 3 is a drawing illustrating a process of interacting with the VOD system, according to a preferred embodiment of the present invention.

FIG. 4 is a drawing illustrating a process of selecting the titles on the P500 list, according to a preferred embodiment of the present invention.

FIG. 5 is a drawing illustrating a process of selecting the titles on the T10 list, according to a preferred embodiment of the present invention.

FIG. 6 is a drawing ______

FIG. 7 is a drawing ______

### DETAILED DESCRIPTION OF PREFERRED EMBODIMENTS

The Adaptive Video-On-Demand (VOD) File Control System according to the preferred embodiment serves two primary objectives. First, the system provides subscribers with a real-time VOD experience, preferably using an adaptive or self-learning file transfer method and a Tempo-Differential file transfer and delivery method. That is, instead of delivering video streams directly from a head-end video processor, the system, either in whole or in parts, preloads a selection of videos on a subscriber's set top box (STB) based on a usage profile, and additionally provides a method to download and play other videos whenever the subscriber wants. Thus, the subscriber's STB preferably completes the video file transfer initiated prior to actual play, but is also capable of processing the video file transfer while the subscriber is viewing the video being transferred.

Second, the preferred embodiment allows a service operator to establish an economically scalable VOD service to subscribers, without requiring substantial bandwidth purchases and massive capital expenditures typically required for head-end video processors. The subscriber, for purposes of example, is assumed to be a xDSL subscriber, but any communication service could be used.

Unlike other VOD system designs, the Adaptive File Control System disclosed herein preferably operates in a three-level interactive topology to push data (such as videos) in a cascade fashion directly to the subscriber's STB. Pushing is the act of automatically initiating a video file transfer without the video having actually been ordered. The adaptive method ensures that the videos most likely to be selected by any user will be pushed to the user's STB, preferably pre-loaded onto the user's STB. Thus the number of “missed” (unavailable locally) videos will be reduced, and the videos likely to be selected will be already on the STB or on the device closest to the subscriber, (for example, the COS) thereby reducing the cost of video delivery.

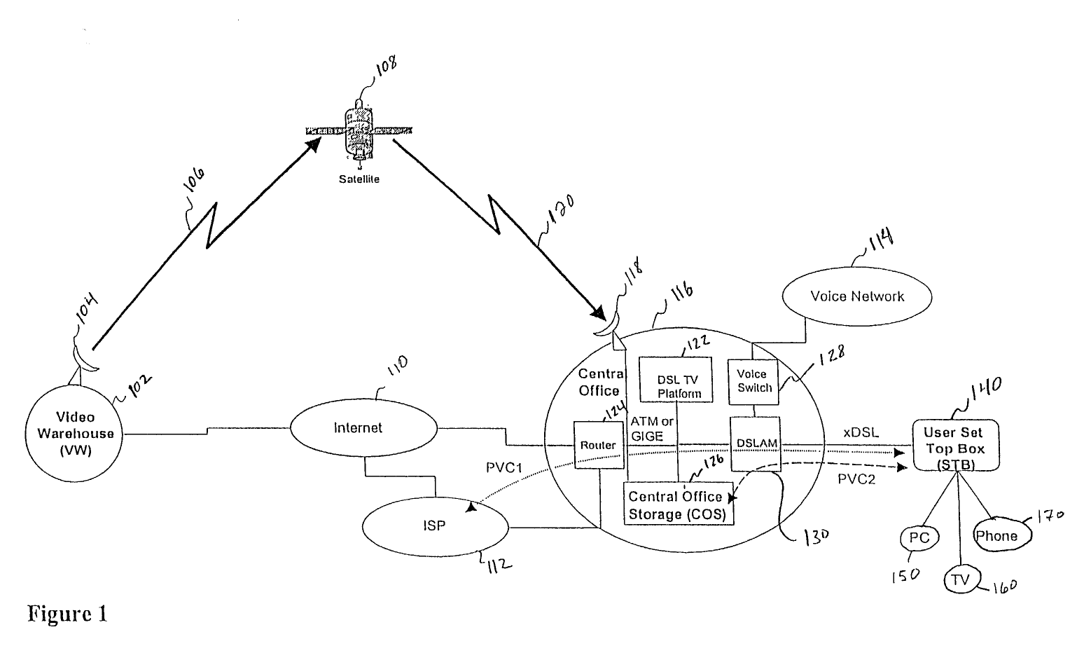

The Adaptive VOD File Control System according to a preferred embodiment of the present invention is illustrated in FIG. 1, and uses a hierarchical network design. Referring to FIG. 1, the system preferably includes a video warehouse (VW) 102, a Central Office Storage (COS) 126, and a user/subscriber set-top-box (STB) 140.

The VW 102 preferably stores any number of video data files. These data files could be stored on any medium suitable for storing data, such as a hard drive, electronic buffer, or optical storage media. The VW 102 preferably includes a high speed connection to the internet 110, as well as a satellite communication uplink link 106 and satellite communications downlink 120. It is possible also that the VW 102 be a “mirror” site. That is, the video data could be stored at remote locations, with the VW 102 serving as a conduit to channel data to the various COSs 126. Additionally, there could be several Vws 102, each having a different selection of data, and each in communication with the various COSs 126. Finally, it is possible for the VW 102 to be in direct connection with user's STBs 140. Any communications link could be used for such a connection.

The COS 126 is preferably located in a Central Office 116, which is communicatively coupled via satellite 108 over satellite paths 106, 120. The VW 102 thus sends video data stored therein to the COS 126 over the satellite links 106, 120. Alternatively, the VW 102 could send the video data files to the COS 126 through the Internet 110. Accordingly, if the satellite 108 should lose communication with either or both of the VW 102 and the satellite antenna 118 at the Central Office 116, video files could still be transferred over the Internet 110. It should be understood that the COS 126 could be any type of storage device or medium, for example, a large capacity high speed hard drive.

The COS 126 is preferably housed in the Central Office 116. As such, the COS 126 could be part of an integrated services system. The Central Office 116 preferably includes a router 124 coupled to the Internet 110 and an Internet Service Provider (ISP) 112. The Central Office also includes a digital subscriber line (DSL) TV platform 122 that receives broadcast or satellite TV signals for transmission over DSL lines. The DSL TV platform 122 and the COS 126 are coupled to a digital subscriber line accessed multiplexer (DSLAM) 130 to send video data to a user's STB 140. Although the system being described contemplates using a subscriber line, such as xDSL, it should be understood that any connection between the COS 126 (or the Central Office 116) and the STB 140 could be used. It is preferable, however, that the connection be a high speed and high bandwidth connection. For purposes of example, a xDSL connection will continue to be described.

The STB 140 is preferably configured to be coupled to a user's television. The STB 140 includes a memory capable of storing video data files, and would preferably have a storage capacity of 40 to 50 gigabytes. Additionally, the STB 140 could be a fully integrated device, allowing a user to couple a personal computer 150, a telephone 170, as well as a television 160 to the STB 140.

It should be understood that the STB 140 could be any device, including memory within a television unit, a DVD player, or Digital Video Recorder (DVR), or any PDA device that is capable of data storage and establish an appropriate communications link. Additionally, the COS 126 can likewise be any device capable of storing information. It is preferably located at a Central Office, but could be located at any remote location. Additionally, the VW 102 can be any storage medium, and can be coupled to the COS 126 in any manner, and need not be by satellite relay. For example, the COS 126 and the VW 102 could comprise a single memory and processing device. The COS 126 would thus store all of the video data available to the system, and perform usage profile analysis. In this respect, the VW 102 would not be necessary as each COS 126 would take the place of the VW. It would also be possible to eliminate the COS 126 and/or the Central Office 116 using a high-speed satellite connection to the STB 140. Additionally, if the STB 140 were part of a mobile communications device or a PDA, then a subscriber could access data and have that data pushed to the mobile STB 140 directly from the satellite. Such a configuration could also be used for fixed location STBs, such as a home television, without needing the Central Office 116 or COS 126.

As illustrated in FIG. 1, the system allows for multi-service integration. Thus, along with video on-demand, the system can provide Internet access, voice services, data services, and free and paid television services over xDSL. Other services are also possible, and this listing is given by way of example only. While this disclosure focuses on xDSL (ADSL and VDSL) access, the disclosed system can be configured for use with a cable modem (e.g., HFC system) or wireless broadband (e.g., Ka-band satellite) access technologies. For example, the STB 140 could be integrated into a cellular phone or wireless PDA.

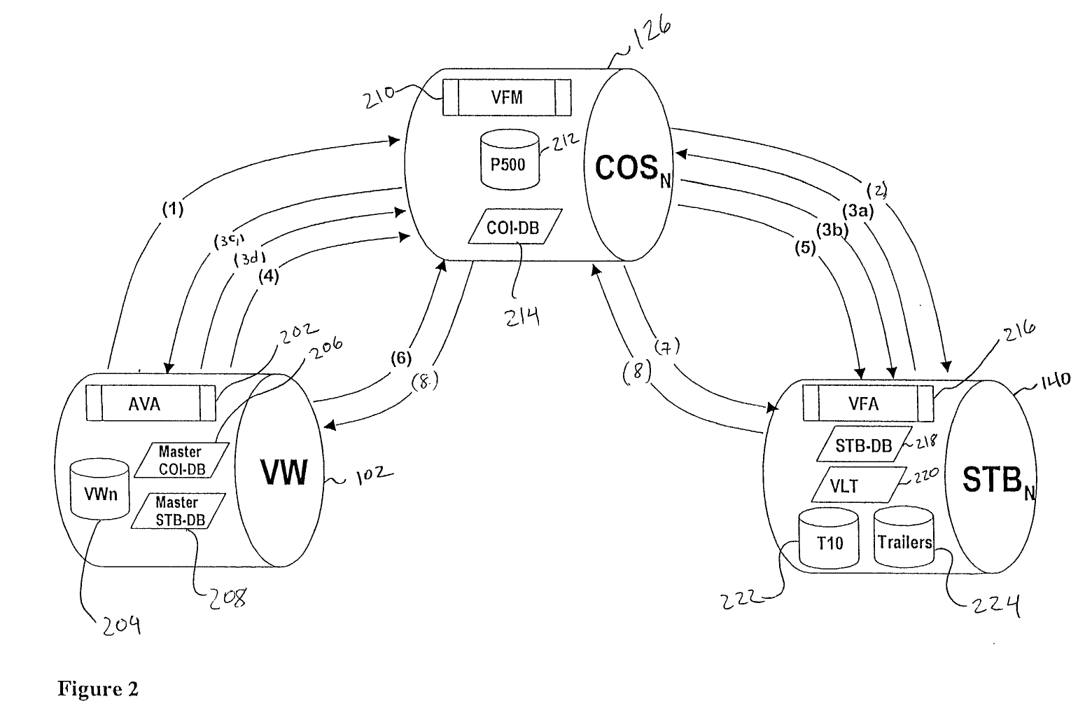

The interaction among the three functional elements is illustrated in FIG. 2. Additional details of each element and an operation of the preferred embodiment are described next.

Referring to FIG. 2, the video warehouse 102 preferably includes an adaptive video file analyzer (AVA) 202, a master community of interest database (COI-DB) 206, a master set top box database (STB-DB) 208, and video warehouse memory (VWn) 204.

The master STB-DB preferably captures and analyzes rental statistics for each subscriber STB (obtained from each STB-DB 218) and encircles the system to determine a usage profile for each subscriber.

Each COS 126 preferably includes a video file manager 210, a community of interest database (COI-DB) 214, as well as a storage medium 212 for storing video data. The COS 126 typically stores more video data than the individual STBs 140, but less video data than VWm 204.

Each STB 140 preferably includes a Video File Agent 216, a STB-DB 218, a video look up table (VLT) 220, as well as various storage media. The storage media preferably

In a preferred embodiment, the VW 102 is communicatively coupled to the COS 126, and the COS 126 is communicatively coupled to each subscriber's STB 140. These couplings are shown as Paths 1-8 on FIG. 2. In some instances, however, it may be desirable to have a direct connection between a user's STB 140 and the VW 102. The VW 102 preferably performs a reliable multicast file push using the satellite 108 to deliver various data to the COS 126 servers. (Path 1). The VW 102 preferably uses a multicast file transfer protocol (MFTP), although any protocol could be used.

The VW 102 preferably delivers a popular video mix of 500 videos and games to the COS 126. Such a mix would be derived from user preferences, compiled from STB and COS statistics, and is referred to as the P500 list. Details of this list will be described hereinbelow. Next, a second, shorter list is generated at least partially from the P500 list for each user. This list preferably includes ten titles, and is referred to as the T10 list. It should be noted, however, that any number of titles could be included in the first or second list. The limitations of 500 and 10 is used for example purposes only. Additionally, any criteria could be used to determine which videos and games would be included. Moreover, different COSs (not shown) could receive different mixes of popular titles based on the associated users. The video mix preferably comprises new movie releases, short video series, and video games.

After receiving the popular P500 mix and storing the same in the P500 memory 212, a Video File Manager (VFM) 210 within each COS 126 performs a reliable IP multicast to populate each STB 140 with the T10 videos. (Path 2). This pushing process is preferably done automatically, so that a subscriber would not need to take any action to have the STB 140 loaded with the videos. The videos would preferably be stored in the T10 memory 222. The COS 126 System Operator or the subscriber, through the STB, could override this feature to either prevent the preloading or force the preloading.

The IP multicast is based on an Internet protocol and MFTP, and provides a method of transmitting video data to each of a plurality of STBs 140. Although other protocols could be used depending on the medium of communication, because this example relates to xDSL, the multicast protocol is described. In the preferred embodiment, the IP multicast happens simultaneously to each STB 140 in communication with the COS 126. Simultaneous pushing, however, is not mandatory.

In addition, the VLT 220, which is a directory database file with the inventory of all video titles at each of the VW 102, COS 126, and STB 140, is concurrently pushed to each COS 126, and then multicast to each subscriber's STB 140 for use by the VFA 216. The VLT 220 preferably resides on the STB 140 and is periodically updated by the VFM 210. A subscriber, through the STB 140, or the COS 126 System Operator, however, could either prevent the update or force an update at an unscheduled time.

Each of the described elements in the preferred embodiment will now be described in more detail with reference to FIG. 2.

The VW 102 performs a reliable multicast push, preferably using a satellite link, to deliver prescribed data to the COS 126. (Path 1). Although this could be any data, in the preferred embodiment, the VW 102 pushes video data including a mix of most popular videos (Px), such as the 500 most popular videos (P500). The P500 video mix preferably comprises top new movie releases, short video series, and video games for the prior month, as well as all-time favorite titles. Although it is described here as the 500 most popular videos, any number of titles could be included on this list. P500 is used herein for purposes of example. Any method of determining which videos are included in the popular list can be used. For example, the determination of popular titles could be drawn from rental statistics compiled at video stores or from STB user's requests. Alternatively, titles that were popular at the box office could be assumed to be popular when they are newly released. The preferred embodiment relies on usage statistics to determine the titles with which to populate the COS 126. Details of that process are described hereinbelow.

Additionally, in the preferred embodiment, the list of popular titles will vary from one COS 126 to another. Thus, the VW 102 will not have a single list of popular titles that it pushes; rather it will dynamically modify the list according to the COSs 126 and/or STBs 140 that are receiving the list.

The Adaptive Video File Analyzer 202 (AVA) at the VW 102 is configured to select these videos to be pushed. Over time, the actual number of video titles pushed to the COS 126 may vary from the default value of 500 videos, based on rental profiles of subscribers and the size of the COS 126.

Each STB 140 preferably includes a Video File Agent (VFA) 217. The VFA 216 is preferably a JAVA application, or any thin software client that resides on the STB 140 and manages the interactivity of the STB 140 with the COS 126 and the VW 102. Each STB 140 also preferably includes a VLT 220, listing the available titles on the STB 140, the COS 126, and the VW 102.

When a subscriber requests a specific video, the following actions occur. First, the VFA 216 checks the VLT 220 to determine if a requested video is currently available on the local STB 140 or the COS 126. (Path 3a). If the requested video title is not available on the STB 140, but is available at the COS 126, then a file transfer is initiated to download the requested video to the STB 140. (Path 3b). Tempo-Differential file transfer techniques for performing this download are described hereinbelow. These Tempo-Differential techniques provide the appearance of a real-time VOD system, even though the file must be transferred from a remote location (i.e., the COS 126). Similarly, if the video title requested is not available on the local STB 140 T10 list) or the COS 126 (P500 list), a request for the “missed” title is made to the VW 102. (Path 3c). This request to the VW 102 is preferably made via a terrestrial Internet link 110, using a secure connection to the VW 102. All information on missed video titles is preferably captured by the VFM 210 for subsequent analysis by the Adaptive Video File Analyzer (AVA) 202.

Next, the missed video file is transferred to the COS 126. (Path 3d). The transmission is preferably done via a high-speed satellite connection. The COS 126, in turn, delivers the requested file to the subscriber's STB 140 as described above.

In order to maximize the availability of titles on the COS 126, a local community of interest database (COI-DB) 214 is maintained. The COI-DB 214 is preferably integrated with the VFM 210, and is used to track the rental activity of all subscribers associated with each COS 126. Through a file transfer managed by the VFM 210, each COI-DB 214 for every COS 126 is periodically sent to a Master COI-DB 206 at the VW 102. (Path 4). This transmission is preferably done over a secure terrestrial Internet link 110.

At the VW 102, the AVA 202 analyzes the aggregated Master COI-DB 206 for all COSs 126. Using an intelligent algorithm, as described below, the AVA 202 continuously adapts and compiles an appropriate subgroup of popular videos to be pushed to and stored at each COS 126 based upon the Master COI-DB 206 profile analysis. This adaptive analysis function reduces the number of missed videos at the COS 126 level, thereby minimizing satellite transmission usage to the COS 126. Such a mix would be derived from user preferences, compiled from STB and COS statistics (e.g., the STB-DB 218 and the COS-DB 214). Details of this will be described hereinbelow. In part from this list, a second, shorter list is generated for each user. This list preferably includes ten titles, and is referred to as the T10 list. It should be noted, however, that any number of titles could be included in this second list. Additionally, any criteria could be used to determine which videos and games would be included in this list.

Through periodic IP multicast transmissions, the VFM 210 updates the VLT 220 in the STB 140 (Path 5) when the contents of the VWn storage 204, COS storage 212, or STB storage 222 change. In the preferred embodiment, the VLT 220 serves two functions. First, it provides subscribers with a complete inventory (i.e., a directory) of all videos available through the network. That is, it lists titles available from the T10 memory 222, the P500 memory 212, and the VWn 204. Second, it determines the shortest path for video file flows, thereby minimizing the transport of video content. Specifically, the VLT 220 directs a subscriber's request to the video storage device closest to the subscriber (i.e., either the T10 memory 222 on the STB 140, COS 126, or the VWn 204 on the VW 102). In this way, system efficiency is maximized.

Through a multicast transmission, the VW 102 can send various other data to any or all COSs 126. (Path 6). For example, video trailers promoting certain other videos can be sent from the VW 102 to each COS 126. Similarly, the COS 126 can send various other data to any or all subscribers' STB 140. (Path 7). For example, the VFM 210 can transfer an appropriate subset of video trailers to associated STBs 140, based upon viewing information obtained from each subscriber's STB-DB 218.

It should be understood that the transmissions described are by way of example only, and that any time of data can be sent. Accordingly, in a situation where a PC is connected to the STB, computer programs could be transferred to the PC in a similar fashion.

Additionally, in the preferred embodiment, a file transfer managed by the VFM 210 is used to periodically send the STB-DB 218 from each STB 140 to the COS 126, which in turn file transfers the STB-DB 218 to the VW 102 (Path 8), where the STB-DB 218 is collected into the Master STB-DB 208.

The preferred embodiment of the present invention preferably includes three functional components. These components are an Adaptive Video File Analyzer (AVA) 202, a Video File Manager (VFM) 210, and a Video File Agent (VFA) 216. Details of each of these components are described below.

The Adaptive Video File Analyzer (AVA) 202 preferably resides at the VW 102, and is an intelligent software algorithm. In the preferred embodiment, the algorithm runs on a Unix-based server, but it could be adapted for any platform and/or operating system. The core function of the AVA 202 is to predict community and subscriber selections so that the optimal distribution of videos occurs across the network, including at the STBs 140. By doing so, the AVA 202 enables STB-centric video processing for a scalable VOD service growth and minimizes the network bandwidth and network equipment required in providing a VOD service. The AVA 202 preferably analyzes video rental statistics collected from each COS 126. In the preferred embodiment, the AVA 202 analysis of the COS 126 statistics is based on a community of subscribers, while the analysis of the STB 140 is based on individual interests.

The VW 102 preferably maintains an inventory list of all titles stored in the Vwn 204 memory. All video titles included on the inventory list for the VWn 204 are preferably assigned a Weighted Ranking Factor (WRF). In the preferred embodiment, every video title is analyzed and ranked based on the total number of views. Additionally, a weight is given for “all-time-favorite” and “new release” status. The steps to maintaining and updating the VWn 204 list are described next. It should be understood that any ranking system could be implemented, and that this system is given by way of example.

First, the videos are sorted from highest to lowest using a Video Number based on an aggregated Master COI-DB 206 and Master STB-DB 208 which are preferably maintained at the VW 102. This is done according to the “Total Monthly Rentals for All COS” parameter. Video titles with the fewest number of viewings during each monthly evaluation period and below a WRF cutoff value are preferably removed from the VWn 204 memory and archived. In addition, the titles for such videos are deleted from the VWn 204 inventory list. The WRF cutoff value is the WRF for the video that has a rank of x, where x is equivalent to the total videos on the VW 102 server minus the total number of All-Time-Favorite and New Release videos. That is, the VWn 204 memory has storage capacity for x videos and games. A certain storage capacity is reserved for “all-time favorites” and new release videos. The remaining portion of the memory is available for storage of the popular or frequently used titles. It should be understood that as the storage capacity increases, so does the number of titles that can be stored.

Certain video titles are given an “All-Time-Favorite” tag and are assigned a minimum WRF that is equal to the WRF cutoff value. This minimum WRF ensures that a video with an “All-Time-Favorite” tag remains in the VWn 204 storage, even if the actual number of monthly views drops below the WRF cutoff value.

Additionally, new release video titles are given a “New Release” tag and are assigned a minimum WRF that is equal to the WRF cutoff value. Again, this minimum WRF ensures that a video with a New Release tag remains in the VWn 204, even if the actual number of monthly views drops below the WRF cutoff value. The New Release tag could be applied to a video for any number of months after its release. After this time period, the New Release tag would be dropped and the video could be evaluated solely on frequency of use.

Other categories could be added that would ensure that certain titles remain in the VWn 204 storage. These categories could be identified and corresponding videos could be tagged. For example, “seasonal favorites” could be established for videos that are popular at particular times of the year. Any number of categories could be designated, and the tagging could be done manually or automatically.

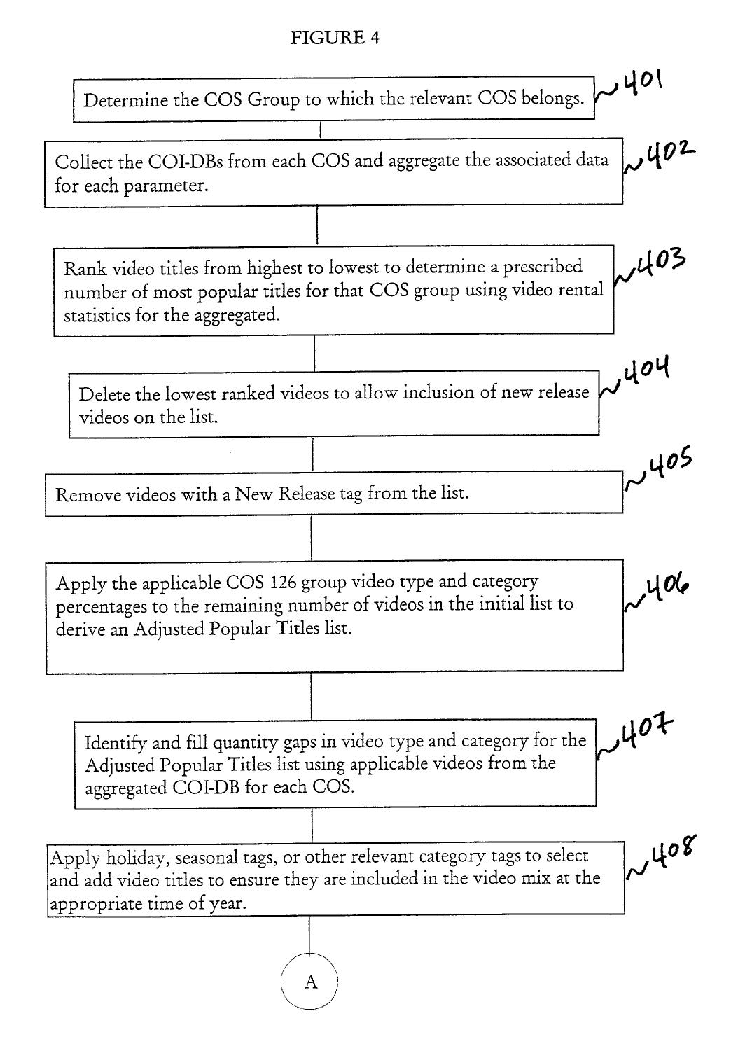

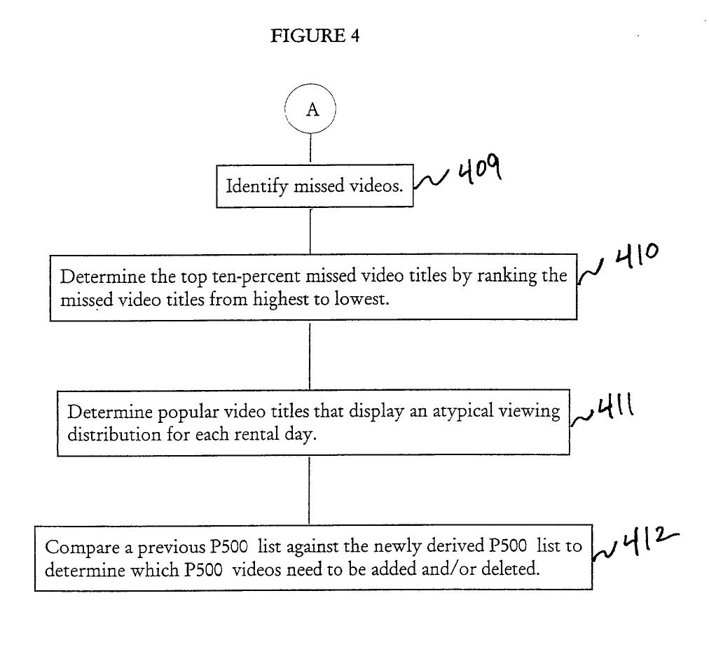

The list of popular titles (the P500 list) can be established for each COS 126, or for a group of COSs. In the preferred embodiment, 500 titles are stored on the COS (p500). Accordingly, the list of titles will be referred to as the P500 list. The AVA 202 preferably analyzes the Master COI-DB 206 records that were collected from each COS 126 and calculates the optimum mix of popular video titles. The final P500 mix for each COS 126 is preferably established through a multi-level analysis using video rental counts from various COI-DBs 214, as well as video type percentages and preferred video category percentages. The P500 list 212 for each COS 126 is preferably updated on a monthly basis, and the associated videos and games are distributed to corresponding P500 memory 212 during off-hours (e.g., Sunday 02:00 to 05:00). It would be possible, however, to allow more frequent analyses and file transfers of titles. Additionally, if a service operator knew of an impending high demand for a video, the operator could manually initiate a file transfer procedure to the COS 126. An outline of a preferred method of the P500 selection criteria is next described with reference to FIG. 4.

First, the COS Group to which each COS 126 belongs, if any, is determined (Step 401). This is preferably based on video type and category mix and is described in more detail below. Next, the COI-DBs 214 from each COS 126 are collected and the associated data for each parameter is aggregated under the applicable COS Group (Step 402). Then, using video rental statistics for the aggregated COS 126 group database, video titles are ranked from highest to lowest to determine a prescribed number of most popular titles for that COS 126 group (Step 403).

Next, the lowest ranked videos from the initial P500 list 212 are deleted to allow inclusion of new release videos on the P500 list 212 (Step 404). For example, if there are 10 new releases for the month, the 10 lowest ranked videos are removed and the 10 new releases are inserted. Also, videos with a New Release tag are removed from the initial popular titles list (Step 405). The applicable COS 126 group video type and category percentages are then applied to the remaining number of videos in the initial P500 list to derive an Adjusted Popular Titles list (Step 406).

At this time, quantity gaps in video type and category are identified for the Adjusted Popular Titles list for each COS 126 (Step 407). The quantity gaps in video type and category are filled by using applicable videos from the aggregated COI-DB 214 for each COS 126 group (Step 407). If gaps still remain, applicable videos from the VWn list with the highest WRF value are used to fill the gaps.

Next, holiday, seasonal tags, or other relevant category tags, are applied to select and add video titles to ensure they are included in the video mix at the appropriate time of year (Step 408). The outcome is the P500 list.

Minimum percentages can be established for the various video types and categories to ensure multiple selections are available on each COS 126 for video types and categories. These percentages could preferably be derived during service trials and refined over time.

Additional techniques could be used to ensure the availability of titles for the COS 126. For example, a COS 126 group could be established based on demographic profiles. That is, subscribers connected to each COS 126 tend to form a unique usage profile or community of interest. This information could be captured in the COI-DB 214. Several COI-DBs may have similar profiles or usage preferences, due to similar demographics (e.g. age, sex, and ethnic background). As a result, COSs 126 can be grouped to more accurately predict video selection criteria. A purpose of this grouping is to tailor the COS storage 212 selection of videos for each COS 126, so those subscribers could access a more relevant mix of videos from their local COS 126. Next, the COS 126 is populated with a popular mix P500. A similar weighting scheme could be used for COS 126 populating as used for VW 102 populating.

In addition, COS 126 groupings allow the service provider to deliver tailored information such as advertising, infomercials, and movie trailers that are relevant to subscribers connected to the COS 126. As a result, sponsors or producers can advertise highly segmented and targeted information to the various subscriber groups of the VOD service provider. For example, some COS 126 may have predominantly Hispanic Americans renting videos. The usage profiles for such Hispanic Americans could be different from predominantly Chinese American subscribers connected to another COS 126. On the other hand, predominantly Hispanic Americans renting videos from a third COS 126 may have a similar usage profile to those of the first COS 126.

Finally, COS 126 groupings provide a focused and more statistically significant database given the larger pool of similar subscribers. By grouping by the COS 126, the COS storage 212 list could have less missed hits at the COS 126 when the COS storage 212 list is created, and service delivery costs can be minimized. The process of using the COI-DBs 214, and forming groupings for COSs 126 is described next.

First, the COS 126 Group to which each COS 126 belongs is determined based on prescribed criteria, such as video type and category mix. This is preferably done on a monthly basis by comparing the video type (i.e., games, films, short video series, etc.) and category (i.e., comedy, drama, etc.) percentage mix for a COS 126 against the established percentages for the COS 126 Groups. If the actual percentage mix for a given COS 126 differs by a prescribed percentage from a COS 126 Group's established percentage mix, that COS 126 Group's percentages are used for the COS's final percentage mix. This grouping analysis preferably provides an optimum percentage mix of video types (games, short video series, and movies) and video categories (e.g., comedy, drama, etc,) to be included in the P500 212 so that the items in the highest demand are located on the COS 126. Based on statistical correlation results, at least two COSs are matched to a COS 126 Group.

Next, management of the COI-DB will be described. For each P500 video title stored at the COS 126, a unique record in the COI-DB 214 would preferably be assigned. When a subscriber requests a particular P500 video title from the COS 126, the associated COI-DB 214 record would be updated to reflect rental frequency and other statistics. Several COI-DB 214 parameters are described in Table 1. The items in Table 1 are shown as a preferred set of parameters. Different parameters could be used in place of or in addition to these to add different or more functionality.

TABLE 1

| COI-DB Parameter | Data |
|---|---|
| CO Number | 0250 |
| COS Group | A5 |
| Video Number | A1111 |
| Video Name | The Famous Movie |
| Video Type | Movie/Game/Short Video |
| Video Category | Science |
| | Fiction/Comedy/Drama/ |
| | Adventure/Children/Instructional/ |
| | Adult/News/Foreign |
| Season or Holiday | None/Christmas/Easter/Summer/ |
| | Winter/Fall/Spring |
| P500 Duration (Days) | 340 |
| P500 Missed Hit Rate | 0 |
| Number of Rentals | 15 |
| Peak Rental Day | Friday |
| Peak Rental Time | 8:05 PM |
| Reserved 1 | Data 1 |
| Reserved 2 | Data 2 |
| . . . | . . . |
| Reserved N | Data N |
| Video Introduction Date | 01/11/00 |
| (Master COI-DB Only) | |
| New Release Tag | Yes/No |
| All Time Favorite Tag (Master | Yes/No |
| COI-DB Only) | |
| Total Monthly Rentals for ALL | 340 |
| COS (Master COI-DB Only) | |
| YTD Total Rentals (Master | 7510 |
| COI-DB Only) | |
| Master Reserved 1 | Data 1 |
| Master Reserved 2 | Data 2 |
| . . . | . . . |
| Master Reserved N | Data N |

The VFM 210 updates and maintains the COI-DB 214 for future analysis by the AVA 202. The AVA 202 would periodically retrieve a complete set of COI-DB 214 records associated with the P500 video titles stored on the COS 126. The VFM 210 then sends these records from the COS 126 to the VW 102, where each COI-DB 214 could be aggregated into a Master COI-DB 206 for detailed analysis by the AVA 202. In the preferred embodiment, the COS 126 is coupled to the VW 102 via a secure Internet link 110 or any secure communication medium and transmits the records over this link.

Referring back to FIG. 4, video titles included in the P500 memory 212 can be further analyzed at this point. For example, missed video hits for each COS 126 or COS Group are first identified (Step 409). For each COS 126 or COS Group, the missed video titles are ranked from highest to lowest, to determine the top ten-percent missed video titles. (Step 410). The top ten-percent missed video titles can then be included in the P500 list 212 for each COS 126 or COS Group.

Additionally, for each rental day, the system can determine if there are any video titles that are popular, but display an atypical viewing distribution, e.g., a short-series video viewed on one day of the week. Prior to the next viewing day, an updated P500 list 212 can be sent to the appropriate COS 126 or COS Group (Step 411).

Finally, on a monthly basis, the AVA 202 can compare the prior month's P500 list against the newly derived P500 list to determine which P500 videos on each COS 126 need to be added and/or deleted (Step 412). Based on this variance analysis, the AVA 202 could send a job request to the VFM 210 directing it to delete videos from P500 memory 212 not on the latest P500 lists. Concurrently the AVA 202 could make multicast transmissions to COS 126 Groups to populate missing P500 video selections. Each COS 126 could be instructed by the AVA 202 to receive a specific multicast transmission if a particular video title is missing from its new P500 list.

To further ensure a real time VOD experience, certain titles are preloaded on the STB 140 and stored in the T10 memory 222. These titles, the T10 list, will typically vary for each STB 140 and are based on individual user preferences. In the preferred embodiment, the STB 140 has enough storage space 222 to store at least 10 full length videos. It has further memory 224 to store other data, such as trailers, commercials, and studio logos, for example. Additionally, the STB 140 has storage space in the T10 memory 222 for at least one additional video that is not on the list. For purposes of example, the preloaded videos will be referred to as the T10 videos.

The AVA preferably uses the Master STB-DB 208 information from each subscriber, and/or an on-line subscriber questionnaire, to determine an appropriate mix of T10 videos to be pre-loaded into each STB 140. The STB-DB 218 information is preferably collected from each subscribers' STBs 140 on a monthly basis during off-hours. The frequency of collection can be modified to accommodate varying needs. The STB-DB 218 information is then aggregated on the Master STB-DB 208 at the VW 102. By analyzing the Master STB-DB 208, the AVA 202 determines the T10 video mix for each STB 140 that best fits the usage profile and preferences of the subscriber. In this manner, only a relevant selection of new releases and preferred-category videos is stored in the T10 memory 222. This reduces the load on the COS 126 file server and also minimizes the possibility that a video file would need to be fetched from the VWn 204. Additionally, it increases the effectiveness of the real time VOD system. It should be noted that the analysis to produce the T10 list could take place at the COS 126, at a remote analysis center, or at the VW 102.

The T10 list is preferably divided into two sections: New Release Videos (NRV) and Preferred-Category Videos (PCV). The PCV component tailors the T10 video mix based on usage history for each subscriber. The appropriate percentage mix on each subscriber's STB 140 for NRV and PCV could vary from user to user. The percentage mix is preferably determined using a variety of factors. For example, items such as year-to-date (YTD) video rental statistics for new releases from the STB-DB (218), percent mix for Favorite Categories and Topics specified by subscribers through an on-line registration and/or subscriber questionnaire, or YTD video rental statistics for all videos from the STB-DB 218.

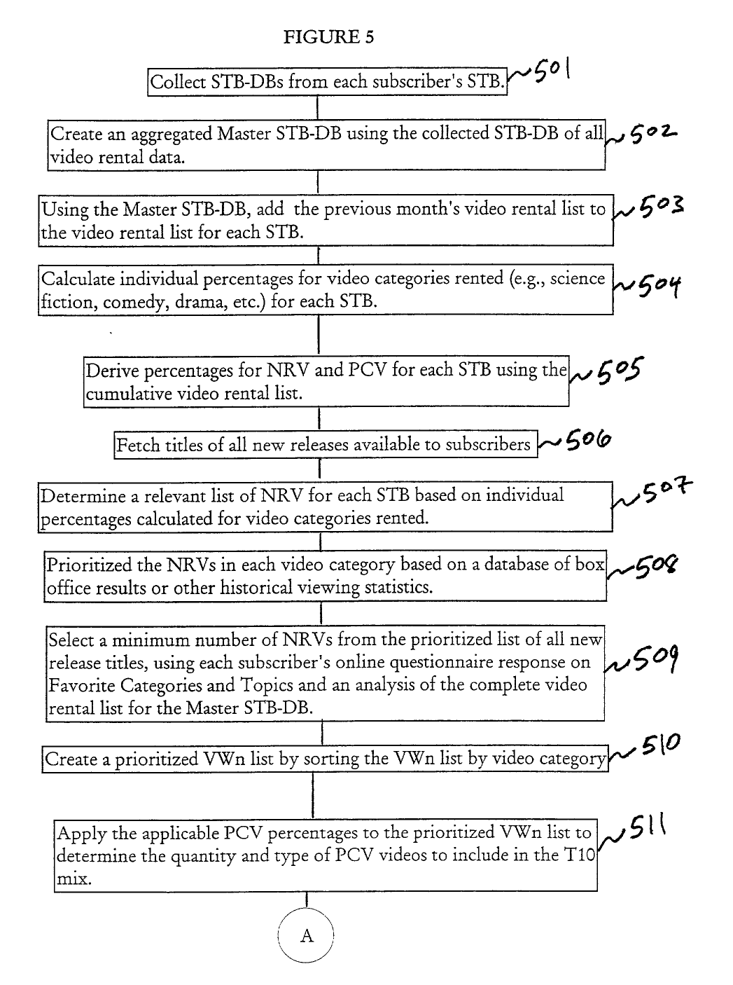

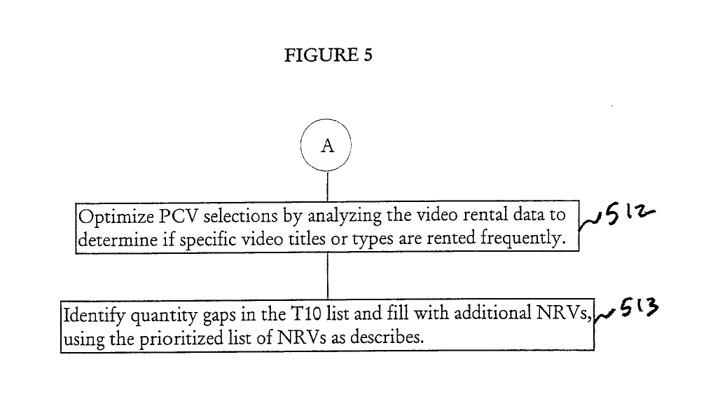

A preferred method for analyzing and calculating the T10 list will be described with reference to FIG. 5. First, the VFM 210 collects STB-DBs 218 from each subscriber's STB 140 on a regular basis (Step 501). For purposes of example, it is assumed that this will take place monthly. Next, the AVA 202 captures STB-DB 218 data from each VFM 210, and creates an aggregated Master STB-DB 208 at the VW 102 of YTD video rental data (Step 502). This aggregate preferably covers YTD data, but could analyze any block of data. Then, using the Master STB-DB 208, the previous month's video rental list is added to the associated YTD video rental list for each STB 140 (Step 503).

Next, individual percentages for video categories rented (e.g., science fiction, comedy, drama, etc.) for each STB 140 are calculated using the YTD video rental list (Step 504).

Then, using the YTD video rental list that incorporates STB 140 Rented Video Records, percentages for NRV and PCV for each STB 140 are derived (Step 505). A sample Rented Video Record is shown in Table 4.

TABLE 4

| | New | | | | | Video | | | |
|---|---|---|---|---|---|---|---|---|---|
| Video | Release | Category | Seasonal | Video | Studio | Trailer | # of | Reserved | Reserved |
| Number | Tag | Tag | Tag | Source | Clip # | Mix # | Views | Parameter | Parameter |
| C3333 | Yes | Comedy | Christmas | COS | S676 | VT12000 | 4 | 0 | 0 |

Titles of all new releases available to subscribers are then fetched (Step 506), and a relevant list of NRV for each subscriber is selected based on individual preferences, which are calculated from percentages of video categories rented (Step 507). The NRVs in each video category are prioritized based on a database of box office results or other historical viewing statistics (Step 508).

A minimum number of NRVs are then selected from the prioritized list of all new release titles, according to each subscriber's profile, which is derived from online questionnaire responses of Favorite Categories and Topics and an analysis of the YTD video rental list for the Master STB-DB 208 (Step 509). For purposes of example, the minimum number of NRVs is five. Next, the VWn 204 is sorted by video category and ranked in descending order by WRF to create a prioritized VWn list (Step 510). Finally, to determine the quantity and type of PCV videos to include in the T10 mix applicable PCV percentages are applied to the prioritized VWn list (Step 511).

To optimize PCV selections, the YTD video rental data is analyzed to determine if specific video titles or types are rented frequently (Step 512). For example, if the YTD list shows that “Sesame Street” videos are rented very often, then new releases of Sesame Street or any children is educational videos can be inserted into the PCV mix. Any quantity gaps in the T10 and preferably filled with additional NRVs, using the prioritized list of NRVs (Step 513).

Other data can be preloaded onto the STB 140 as well. For example, as will be described in greater detail below, it can be advantageous to first display short preloaded video clips, such as movie trailers or advertisements, prior to showing a selected video. To increase the probability that a viewer will watch the trailers and advertisements, the preloaded trailers clips can be selected based on the subscriber's profile. This information is preferably stored in memory 204 of the STB 140.

Based on subscriber profile information of preferred video categories and usage data in the Master STB-DB 208, the AVA 202 preferably directs the VFM 210 to transfer a relevant subset of video trailers, clips, and advertisements to the subscriber's STB 140. This action serves at least two purposes. First, by selecting relevant video trailers, the subscriber is more likely to have an interest in the film, and thus more likely to rent the video. Second, because of preference and relevance, the subscriber can more likely watch the video trailer in its entirety. Because the STB 140 can buffer the selected video while the trailer is playing, a higher percentage of the STB 140 local video buffer could be filled by the COS 126 or VW 102 prior to actual playing of the selected video.

In the preferred embodiment, a suite of video trailers is preferably preloaded into each STB 140 and each trailer is tagged with a video category code. The entire suite of preloaded video trailers preferably allows for approximately 60 video trailers, although any number could be used. When a subscriber selects a video, the VFA 216 preferably determines an appropriate subset of video trailers to be applied for the selected video. This allows for fewer repeats and attracts the attention of the subscriber prior to playing the selected video. The video trailer selection analysis is performed utilizing subscriber profile information, including preferred video categories, the Master STB-DB 208, and the video category code for the selected video.

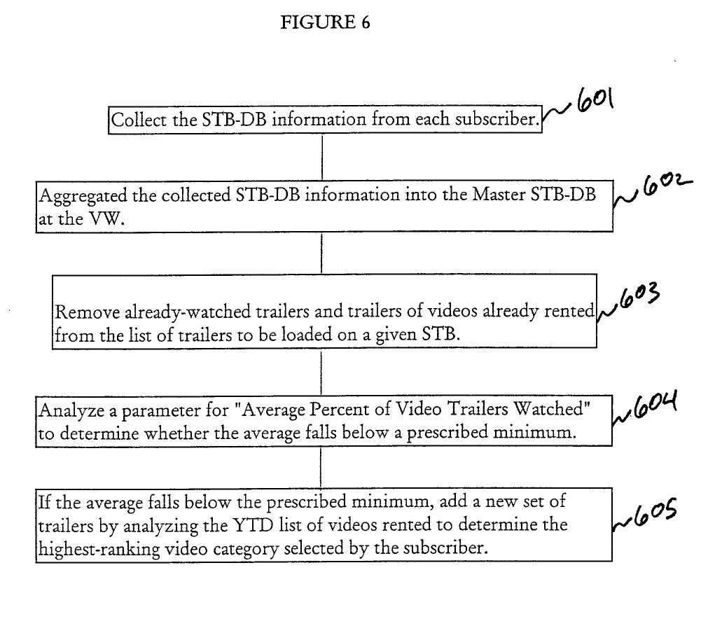

A preferred method for analyzing and selecting the video trailers is described next with reference to FIG. 6.

First, the STB-DB 218 from each subscriber's STB 140 is collected on a regular basis, for example, monthly (Step 601). The collected STB-DBs 218 are then aggregated into the Master STB-DB 208 at the VW 102 (Step 602). Using this information, the list of trailers to be loaded for a given STB 140 is modified to remove both already-watched trailers and trailers of videos already rented (Step 603).

Next, a parameter for “Average Percent of Video Trailers Watched” is analyzed (Step 604). If the average falls below a prescribed minimum, such as fifty percent, a new set of trailers are added by analyzing the YTD list of videos rented to determine the highest-ranking video category selected by the subscriber (Step 605).

In the preferred embodiment, the COS 126 stores all trailers associated with the P500 list. Based on subscriber profile, the AVA 202 sends a list of appropriate trailers to be downloaded to each STB 140. The VFM 210 uses the trailer list to push video trailer files from the COS 126 to the STB 140 memory for trailers 224.

The Video File Manager (VFM) 210 preferably resides on the COS 126. The COS 126 can be any storage medium, but is preferably a high performance server with a high-speed input/output device, a high capacity hard disk drive, a multiprocessor with high-speed bus architecture, and a high capacity Dynamic Random Access Memory and Cache. The VFM 210 provides an intelligent interface between the STB 140 and VW 102, as well as the interaction between the COS 126 and the VW 102. The VFM 210 preferably performs multiple functions. A description of some of the functions follows.

In the preferred embodiment, the VFM 210 performs a video cache management function. Specifically, when a file requested by a subscriber is not resident on the COS 126, the VFM 210 acts as an intermediary to download the requested file from the VW 102, and then transfers the data to the STB 140. The VW 102 preferably multicasts the video file not only to the VFM 210 that initiated the request, but also to all VFM 210s that are in the same COS Group. Additionally, the VFM 210 retains and manages the missed video titles (non-P500 list) on the COS 126 until a new P500 list is calculated by the AVA 202, or until a prescribed time period expires. The VFM 210 also manages the storage of each P500 video on the P500 list on the COS 126. This includes, for example, formatting the video file by chapters and storing the data in memory, such as the COS 126 hard disk 212.

Because multiple video file transfers may occur at any given time, the VFM 210 preferably prioritizes and calculates which files are to be pushed to subscriber STBs 140. In the preferred embodiment, this calculation is performed by tracking how much data has been transferred to each STB 140, and analyzing each subscriber's viewing profile. The subscriber profile would identify a subscriber's viewing habits, for example, whether the viewer watches a video from beginning to end without interruption, or instead moves from chapter to chapter. The subscriber profile could be stored on the STB 140 and sent to the COS 126 when requested, or the COS 126 could maintain a database of subscriber profiles. As another alternative, the subscriber data could be stored in a remote database, e.g., the VW 102, that the COS 126 can access, and that other applications, including third party applications could likewise access.

The VFM 210 preferably tracks memory reserved on the COS 126 for video titles missed in the P500 list. This reserved storage space preferably comprises approximately 1% of total storage on the COS 126. The missed P500 videos are then prioritized by frequency of use for inclusion in the reserved storage space.

The VFM 210 can also manage the files pushed to the STB 140. For example, the VFM 210 would initiate a file push to subscribers on a multicast basis. The VFM 210 preferably receives data from the VW 102 using a multicast file transfer protocol (MFTP), although any protocol could be used. Other MFTP transmissions could also be performed by the VFM 210. For example, the VFM 210 could be instructed by the VW 102 to receive only video files that are listed on the P500 list for the applicable COS Group. Additionally, the VW 102 could multicast various subsets of video trailers for each applicable COS Group, and each VFM 210 would receive such video trailer subset. The VFM 210 would also receive the P500 list, the T10 list for each STB 140, the Video Trailers list for each STB, and the VWn list from the AVA 202. The VFM could further transfer T10 videos, the VWn list, and video trailers via a multicast to all STBs 140 connected to the COS 126.

It should be noted that the COS 126 could initiate a file transfer, as could a subscriber STB 140. Moreover, a subscriber using a remote communications device, such as a telephone, computer, or wireless communications device, could initiate the file transfer. Thus, the subscriber could determine remotely what titles were available on his STB 140, and could request that a particular title be available at a particular time on his STB 140. If the title were not already at the COS 126, the COS 126 would be able to schedule a retrieval time from the VW 102. Additionally, the requested file could be pushed to the requesting subscriber's STB 140.

The VFM 210 also preferably provides video distribution control from the COS 126 where subscribers are connected. In the preferred embodiment, the VFM 210 server software manages the client VFA 216 software to control several features. For example, the VFM 120 would process the VFA 216 requests for video titles at the COS 126, process the VFA 216 requests for video titles at the VW 102, periodically send the VLT 220 to all VFAs 216 associated with the COS 126, and retrieve STB-DB 218 records from each VFA 216. Additionally, it could aggregate and send STB-DB 218 records (detailed usage report) to the AVA 202 for T10 selection and billing, periodically send updated T10 videos and video trailer mix to the VFA 216 based on the AVA 202 analysis, and control the flow of video file download to each VFA 216 utilizing the Tempo-Differential file transfer method. It should be understood that the VFM 210 software could also be configured to control other aspects of the system.

The VFM 210 maintains all applicable COS Group video trailers used by the associated STBs 140. In a preferred embodiment, this would include all video trailers associated with the P500 videos stored at the COS 126. Periodically, for example on a monthly basis, the VFM 210 would receive video trailers from the AVA 202 and a relevant video trailer list for each STB 140 to be transferred to the VFA 216. The relevant trailers could be selected based on various criteria, such as subscriber profile information of preferred video categories, and the Master STB-DB 208. Other aspects of the selection are described above. The VFM 210 preferably sends these video trailer files, which preferably form a subset of approximately 60 video trailers, to each STB 140 during non-peak subscriber usage hours. A subscriber, however, could request and retrieve trailers at any time using the STB 140, or by accessing the network using any type of communications device.

The Video File Agent (VFA) 216 will now be described in more detail. The VFA 216 is preferably an interactive JAVA client that resides on the STB 140. It could, however, be any application capable of carrying out the functions of the VFA 216. The VFA 216 performs several functions to achieve a real-time video on-demand experience in conjunction with the VFM 210 and the AVA 202.

One functional element of the VFA 216 is the Tempo-Differential file transfer method software. By taking advantage of the latency parameters associated with subscriber decisions and interaction, as well as the ordering/purchasing protocol, a portion or all of the requested video file is preferably pre-loaded in the subscriber's STB 140 prior to playing, thus achieving a real-time viewing experience. By interacting with a distant VFM 210, the VFA 216 receives segments of the video file prior to subscriber viewing, and leverages the download speed differential against the play speed. The VFA 216 also leverages the initial time lag associated with the viewing of local STB 140 movie trailers (pre-pushed by the VFM 210), the video checkout interval, and the account/billing maintenance interval.

The VFA 216 JAVA client determines the availability of a video requested by checking the STB 140 Video Lookup Table (VLT) 220, which is periodically updated by the VFM 210. The VLT 220 preferably comprises T10 videos that are stored on the STB 140, P500 videos stored on a hard disk 22 on the COS 126, and the VWn 204 videos stored at the VW 102. Through a hierarchical menu display, where videos at the VW 102 are on the last set of submenus, a higher priority is given to T10 222 and P500 menus. The VWn list is provided as an additional selection option menu. A higher premium could be charged for VWn titles to encourage subscribers to choose from T10 222 or P500 menus. Using the available list of trailers resident on the STB 140, the VFA 216 also selects an appropriate mix of video trailers for viewing, based on usage profile of the subscriber and the category of video selected.

Detailed usage statistics are maintained by the VFA 216 using the STB-DB 218 records. The VFA 216 preferably updates the STB-DB 218 when a transaction occurs at the STB 140 (for example, a T10 video rental) or between the STB 140 and the COS 126 (for example, a P500 video rental) or the VW 102 (for example, a VWn video rental). Periodically, for example on a monthly basis, the VFM 210 requests and collects the STB-DB 218 records from the VFA 216. A preferred set of parameters for the STB-DB 218 record is shown in Table 2. Different parameters could be used in place of or in addition to these to add different or more functionality.

TABLE 2

| STB-DB Parameter | Data |
|---|---|
| CO Number | 0250 |
| COS Group | A5 |
| STB Number | Z0000001 |
| Subscriber IDs | A0000001, B0000002, C0000003 |
| Video Category Preference | Science Fiction(K)/Comedy(C) |
| P500 Missed Hit Rate | 2 |
| P500 Missed Video Number | K5555, K5555 |
| Average Percent of Video | 95% |
| Trailers Watched | |
| Average Lag Time Between | 7.15 |
| Video Selection & Play (in | |
| Minutes) | |
| List of trailers watched and | P8888, K6666, K7777, C2222, |
| rented this month | A0009 . . . |
| Peak Rental Day | Saturday |
| Peak Rental Time | 8:05 PM |
| Current T10 NRV List | A1111, B2222, C3333, D4444, E5555, |
| | F6666 |
| Current T10 PCV list | G7777, H8888, I9999, J0000 |
| Active Video Rental List | K5555, C3333 |
| (Cached either 2 days or 1 week) | |
| Number of Rentals for this | 8 |
| month | |
| STB Rented Video Record #1 | xxxC3333 |
| (see Table 4) | |
| STB Rented Video Record #2 | xxxG7777 |
| . . . | . . . |
| STB Rented Video Record #N | xxxD4444 |
| Reserved 1 | Data 1 |
| Reserved 2 | Data 2 |
| . . . | . . . |
| Reserved N | Data N |
| Membership Date (Master STB- | 01/01/00 |
| DB Only) | |
| YTD Video Rentals (Available | 22 |
| on VW Master STB-DB) | |
| YTD Video List (Available on | G2345, X6789, . . . Z0900 |
| VW Master STB-DB) | |
| Master Reserved 1 | Data 1 |
| Master Reserved 2 | Data 2 |
| . . . | . . . |
| Master Reserved N | Data N |

The VFA 216 serves as an interactive control interface. That is, from the beginning to the end of a video selection, the VFA 216 manages the subscriber commands.

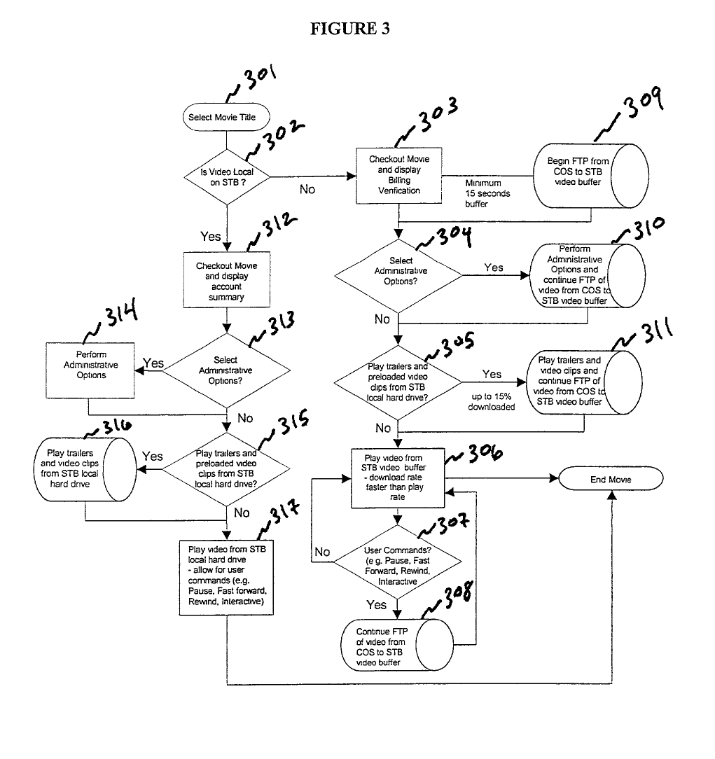

FIG. 3 illustrates how the VFA 216 interacts with a subscriber to provide a real-time VOD experience.

First, a movie title is selected (Step 301). The VFA 126 then determines if the video is currently on the STB 140 (Step 302). If the video is not currently stored on the STB 140, the VFA 216 displays a movie checkout screen and billing verification information (Step 303). This provides a minimum 15 seconds of buffer time. During this 15 second buffer, the requested video file download is initiated from the COS 126 or from the VW 102 to the STB video memory 222 (Step 309). Next, after a movie checkout display, the VFA 216 provides the user with an opportunity to select administrative options (Step 304). If the user chooses to enter the administrative options menu, the VFA 216 continues to download the selected video to the STB video buffer while performing administrative options (Step 310).

If, however, the user opts to bypass administrative options, the VFA 216 begins playing trailers and video clips stored on the local hard drive 224 of the STB 140 (Step 305). It is possible for the VFA 216 to either automatically begin playing the trailers, or to prompt the subscriber to begin playing the trailers. Alternatively, the user could skip over the trailers one by one, or in their entirety. While the trailers are being displayed, the file transfer of the selected video continues (Step 311). If the subscriber opts not to play trailers or skips over them, the VFA 216 begins playing the selected video that has been buffered up until that point (Step 306). The file transfer preferably continues at a rate faster than the play rate, such that the entire video is buffered.

If any user commands (Step 307) are received by the VFA 216 while the video is playing, for example pause, fast forward, or rewind, then the video continues to download, if the download has not already completed (Step 308). Various download methods are also available. Based on the subscriber's profile, the video is either downloaded from start to finish, or has portions of each chapter simultaneously downloaded, such that portions of each chapter are buffered in case the user skips to a subsequent chapter.

If, in step 302, it is determined that the video is stored on the STB video memory 222, then the VFA 216 displays a checkout movie screen and an account summary screen (312). The VFA 216 then prompts the user to either select or not select administrative options (313). If administrative options are selected, they are performed (314). Otherwise, trailers and preloaded video clips are played (315). Again, the user is given the option to skip over these, or skip from one to another. In the preferred embodiment, the VFA prompts the user to determine if the trailer should be played. If the user decided to play the trailers, they are played from the STB local hard drive 224 (316). Otherwise, the video begins playing (317).

In the preferred embodiment, a Tempo-Differential file transfer method is used to achieve real time video on demand. The Tempo-Differential file transfer method uses various buffering schemes to generate a time lag between when the user requests a video and when the video begins playing. In this way, the video can be downloaded while the user is interacting with other system command and response related tasks.

When used in the manner described below, the Tempo-Differential file transfer method in combination with the adaptive capabilities of the VOD system achieves a real time VOD viewing experience. The Tempo-Differential file transfer method can preferably enhance buffering, especially when the selected video is not preloaded as part of T10 videos on the STB 140 local memory 222.

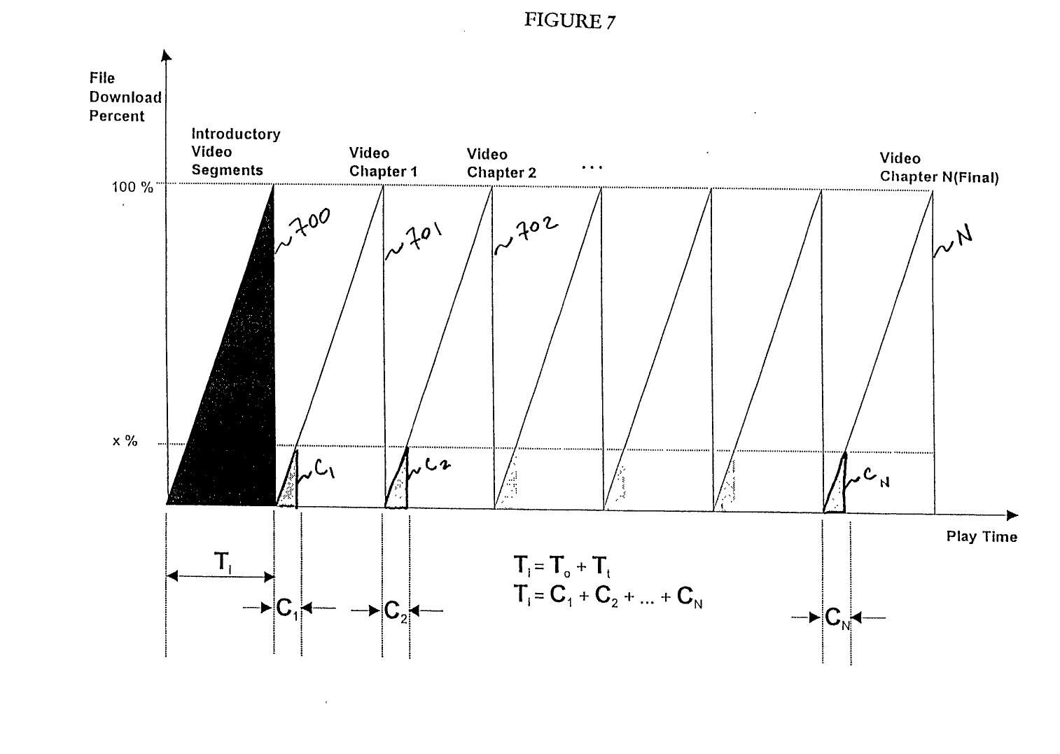

Referring to FIG. 7, the Tempo-Differential file transfer method leverages time differential factors to optimize buffering. In the preferred embodiment, two time differential factors are leveraged. The first is the subscriber decision process time delay (Tₒ), and the second is the time delay caused by viewing preloaded generic and customized video clips (Tₜ). The first delay factor, Tₒ, occurs in real-time, while the subscriber interacts with the VOD system. Specifically, after the subscriber selects a video, the download begins immediately. However, the selection menus/screens require the subscriber to complete the order process. This gives the VOD system a head start on the initial buffering of the selected video while the subscriber makes the various decisions required to complete the order.

The second delay factor, Tₜ, is inherent in a “typical” viewing protocol due to introductory video segments that always occur, in full or in part, when a video selection is made. Based on a subscriber's profile, these short video segments are preloaded into the subscriber's STB 140 local memory 224 prior to any subscriber interaction or selection of the video. When the introductory video clips are viewed, additional buffering of the selected video would continue. These two delay factors allow the system to achieve a perception of real-time VOD experience, without the subscriber having any prior knowledge that the VOD system is buffering the selected video.

The total initial time differential, Tᵢ, gained on video buffering as a result of Tₒ and Tₜ, is most useful when the VOD system can maintain the buffer ahead of the actual play rate. Therefore, for the VOD system to function optimally, the download rate must be consistently greater than the play rate. This requires that the video encoded rate be less than the line speed of the subscriber's connection to the COS 126. For data transmission over a xDSL line from the COS 126 to the STB 140, where a fully dedicated connection exists, a consistent file download rate can be maintained so that the STB 140 local video memory 222 can always be available for the STB 140 video processor. If the rate is slower, additional buffering techniques can be used to achieve the perception of a real-time VOD service. However, a near real-time VOD is possible if the line speed is less than the video encoded rate. This includes notifying the subscriber by pre-checking the line rate. If a consistent line rate is not available to provide real-time VOD, a message of when it would be available would be displayed. Thus, the viewer is informed when the video will be available for viewing. To provide a full screen VHS quality video, a minimum of MPEG2 video encoded at 2Mbps should be used. For Asymmetric Digital Subscriber Line (ADSL) service, customers within 1.51 miles of the Central Office can achieve line speeds of up to 8Mbps, depending on the modem manufacturer. Typically, a complete file download for an average 90-minute MPEG 2 video encoded at 2Mbps may require 25 minutes to download. Table 3 shows average download times (in minutes) for ADSL customers accessing various MPEG2-encoded video files. Other high speed dedicated connections, such as VDSL, will have faster download rates. ADSL is shown as an example.

TABLE 3

| | MPEG2 | | | | |
|---|---|---|---|---|---|
| | Encoding | Video Length | | | |
| ADSL Type | Rate | 30 | 60 | 90 | 120 |
| Full-rate ADSL MPEG-2 Video | 2 Mbps | 8 | 17 | 25 | 33 |
| Download (min) | | | | | |
| Full-rate ADSL MPEG-2 Video | 3 Mbps | 12 | 24 | 36 | 48 |
| Download (min) | | | | | |
| Full-rate ADSL MPEG-2 Video | 4 Mbps | 16 | 32 | 48 | 63 |
| Download (min) | | | | | |
| G.Lite ADSL MPEG-2 Video | 2 Mbps | 44 | 89 | 133 | 178 |
| Download (min) | | | | | |
| G.Lite ADSL MPEG-2 Video | 4 Mbps | 84 | 169 | 253 | 338 |
| Download (min) | | | | | |

If, as a result of time delays Tₒ and Tₜ, five minutes have lapsed before the selected 90 minute MPEG 2 video begins, then the VOD system could preload approximately 20% of the selected video from the COS 126 or the VW 102 on the STB 140 video memory 222. The Tempo-Differential file transfer method can be used with other MPEG formats (e.g., MPEG1, MPEG4, or MPEG7) or any audio or video CODECs encoded at various rates and VDSL lines (up to 52Mbps). Additionally, other dedicated communication connections or network connections with guaranteed bit rate are available, and xDSL service is used by way of example only.

In order to maximize the usefulness of the Tempo-Differential delay scheme, various delay elements are used. Some of the Tempo-Differential delay elements were described above with reference to FIG. 3. Further details of these elements will now be described with reference to FIG. 7.

There are many Tempo-Differential elements that can be inserted into the VOD system to achieve a higher Tempo-Differential, Tᵢ, prior to the viewing of the selected video. The preferred embodiment includes at least the following elements. First, the time lag between screen displays (TSCREEN) is used. This is the short pause between each of the screen displays shown before the movie begins. Next, a billing verification display screen (TBILLING) is used. This screen verifies the video selection and that the subscriber accepts the amount charged for the selected video. In addition to this biling screen, there is optionally a monthly summary screen that gives the subscriber the option to view billing details for the month.

Next, there is an administrative options menu (TADMIN). This screen allows the subscriber to select various format and delivery options, such as a wide screen or standard TV screen display. Additionally, the subscriber can select filmography at this point, such as information and details about actors, producers, scenes, critiques, and product endorsements. These can be fetched by the subscriber before, during, or after the movie. Additional options include subtitles on or off, language selection, and closed caption on or off.

The next delay elements are a service provider promotional/introductory video clips (TSERVPRO), followed by preloaded video trailers (TTRAILER). The video trailer segments are preloaded in the STB 140 memory 224 in accordance with the subscriber's profile. Advertisements/product endorsement video clips (TAD) are used next to delay the selected video. These include product endorsements or advertisements relevant to the video selected by the subscriber (e.g., movie soundtracks on CD and other memorabilia). It should be noted that the subscriber need not engage in viewing any of these delay features, but that the time spent scrolling by each option is itself a delay technique.

Further delay is achieved by preloading in the STB 140 certain generic video clips that are shown with each movie. For example, the Mandatory FBI notice (TFBI) must be displayed, and movie studio or video brand clips can be pre-stored and played based on selected video (TBRAND). The above elements form a cumulative time delay Tᵢ. During this delay time, the selected video preferably continues to be downloaded. Therefore, as the delay elements proceed, data continues to be buffered on the STB video memory 222. The subscriber may decide to skip some elements, and thereby reduce Tᵢ. However, some basic elements, such as billing confirmation for the selected video and the FBI notice, form a minimum level of Tᵢ. Other delay factors can be implemented as well, and can be selected based on a subscriber's profile.

For simplicity, the above described delay elements can be grouped into two categories. First, Subscriber Decision Process Time Delay: To=TSCREEN+TBILLING+TADMIN. Second, Preloaded Generic and Customized Video Clips Time Delay: Tₜ=TSERVPRO+TTRAILER+TAD+TFBI+TTRAILER+TBRAND. Therefore, the total Tempo-Differential, Tᵢ is the sum of Tₒ and Tₜ.

It should be understood that any method could be used to introduce a time delay before video viewing begins and that the enumerated examples are not intended to be limiting. Furthermore, any such method could increase the amount of buffering that occurs, and thus could enhance the real-time VOD experience. It is also possible to preload (push) to the STB 140 several minutes of the first chapter of each video in the P500 list. This would decrease the time delay necessary, because a portion of the selected video itself would already be stored on the STB 140. Thus, if a subscriber selects a video from the P500 list that is not already loaded on the subscriber's STB 140, the subscriber could skip through each of the Tt delay elements and still have no interruption or perceived delay in video viewing. In this manner the Tempo-Differential file transfer method is further enhanced.

Videos transferred to the STB video memory 222 are preferably divided into c hapters. This serves at least two purposes. First, it provides the subscriber the freedom to move from chapter to chapter without having to play through the undesired video chapters. Second, the video chapters can be transferred in a non-linear, weighted distribution that is more heavily buffered in the beginning video chapters.

FIG. 7 provides a graphical illustration on how video chapters 701, 702, . . . N are buffered from the initial Tempo-Differential gain according to a preferred embodiment. Typically, each of the chapters is sequentially downloaded in a linear fashion. A portion of each chapter C₁, C₂, . . . CN, however, is downloaded in parallel, so that if a viewer skips forward to any chapter, there will be at least a small portion of that chapter already buffered. This ensures a higher probability of successful real-time VOD experience without having to wait for any buffering while the video is playing. The chapters for the selected video can be buffered linearly (each chapter gets downloaded simultaneously in equal amounts) or nonlinearly (downloading is exponentially weighted towards beginning chapters or done sequentially through the chapters) based on the subscriber's profile obtained from the STB-DB 218.

By way of example, if a subscriber profile suggests that a particular subscriber is not likely to skip ahead in the video, but instead is likely to watch the video straight through, then very little data on subsequent chapters would be file transferred simultaneously with the first chapter. Thus, the majority of the file transfer goes to the first chapter, and then sequentially through the other chapters. This minimizes the possibility of interruption in service, and the video would be fully buffered for the subscriber to watch. A small percentage, x %, of each chapter, however, would be preloaded.

On the other hand, if a subscriber's profile indicates that the subscriber is likely to skip ahead through the chapters, then the file transfer process can begin transferring each chapter in parallel at a uniform rate so that at least the beginning of each chapter is buffered. Thus, if the subscriber skips ahead to a subsequent chapter, there would be no delay in viewing that chapter. Additionally, if the subscriber's profile indicates that once the subscriber skips to a particular chapter, the subscriber stays on that chapter, the file transfer can be dynamically reallocated to that chapter.

Additionally, as another variation of the Tempo-Differential file transfer, a subscriber could pre-select a video from any remote location using any type of communications device. For example, the subscriber could select a video to watch using a mobile telephone or other wireless communication device (e.g., pager, PDA) through a wireless web interface, or from a PC through a web page. In this way, a subscriber can choose a video and have it loaded to the STB 140 even when the subscriber is not home, and not presently able to watch the video. Then, when the subscriber is ready to watch the video, it would have been preloaded, either partially or entirely, to the STB 140.

The preferred embodiment disclosed herein is based on two-dimensional (2D) video for VOD service. However, the video file could be in three-dimensional (3D) or holographic format for viewing by the subscriber. This could be accomplished with or without external viewing devices. Related art methods for VOD service could be cost prohibitive in offering this type of video format because such systems would require substantial video processing resources at the video head-end. On the other hand, the VOD system of the preferred embodiment leverages the video processing resources of the STB 140 to display such 3D or holographic videos using any laser optics device embedded within the STB 140. This system would require a higher dedicated connection from the COS 126 to the STB 140, such as VDSL (52 Mbps) or Fiber to the Home.

Moreover, the various lists of videos can be defined to meet any criteria. For example, the P500 list could be expanded to a P1000 list or reduced to a P100 list, or any size depending on the circumstances. Additionally, the same holds true for the T10 list. Similarly, the monthly operational cycle used as the preferred embodiment disclosed herein for the service could be performed on a weekly basis, or any other time frames. Additionally, while the system is described as a video on demand system, the concept can be applied to any type of data that any subscriber would require. Additionally, the Tempo Differential file transfer can be used by itself, without the other elements of the system, and each of the other elements can be used alone without the Tempo-Differential file transfer. Additionally, it should be understood that the system could be run on any type of platform using any type of operating system. The examples given in this description are by way of description only, and should not be considered as the only method to achieve the outcome. For example, the systems could be Unix based, Linux based, Mac OS based, or could be Windows based. Additionally, any hardware configuration could be used.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A method of transferring audio-video data, comprising:
receiving a plurality of audio-video data files on at least one remote memory device from at least one data repository;
automatically selecting a plurality of groups of files from the plurality of audio-video data files and transferring each group to corresponding ones of a plurality of local memory devices coupled to the at least one remote memory device, wherein the plurality of audio-video data files is automatically selected and transferred from the at least one data repository in accordance with a result of an analysis of profiles of each of the plurality local memory devices, and wherein each group of files to be transferred to corresponding ones of the plurality of local memory devices is selected according to the profile of the corresponding local memory device to which it will be transferred.

2. The method of claim 1, wherein the profiles indicate previous file selections by users of the remote memory devices.

3. The method of claim 1, wherein the at least one remote memory device comprises a Central Office Storage (COS) device.

4. The method of claim 3, wherein the COS device includes at least one of a hard disk, a buffer, and an optical storage device.

5. The method of claim 1, wherein each of the local storage devices comprises a set-top-box (STB).

6. The method of claim 5, wherein the STB includes at least one of a hard drive, a buffer, and an optical storage device, and is configured to output a video signal to a video display monitor to display the contents of the audio-video files stored on the STB.

7. The method of claim 1, wherein each of the plurality of local memory devices comprises a set-top-box (STB) used in conjunction with a video display monitor to display selected video recordings, wherein the plurality of audio-video data files comprises a prescribed number of most popular feature film video recordings determined in accordance with viewing statistics compiled from each of the plurality of STBs, and wherein each of the plurality of groups of files comprises a sub-set of the most popular feature film video recordings that best match a user interest profile compiled from the user's viewing statistics received from the user's STB.

8. The method of claim 1, wherein the first memory device is located at a central office storage facility, wherein each of the second memory devices is located at a set top box coupled to a video display system, and wherein each of the plurality of set top boxes is coupled to the central office storage facility.

9. The method of claim 8, wherein each of the set top boxes is coupled to the central office storage facility using a Digital Subscriber Line.

10. A video-on-demand file transfer system, comprising:
at least one set top box (STB), configured to maintain a list of available data and store a first prescribed portion of the available data;
at least one central office storage and processing device (COS), communicatively coupled to the at least one STB, and configured to store a second prescribed portion of the available data and maintain a database of activity of the at least one STB; and
a main storage facility, communicatively coupled with the at least one COS, configured to store all of the available data, wherein the first and second prescribed portions of the available data are selected based on at least one of user and community interest profiles.

11. The system of claim 10, wherein the main storage facility and the COS are co-located.

12. The system of claim 10, wherein the first prescribed portion of the available data is a sub-set of the second prescribed portion of the available data.

13. The system of claim 10, wherein the available data includes video recordings of feature films, and wherein the first prescribed portion of the available data includes at least ten of the video recordings, and wherein the second prescribed portion includes at least 500 of the video recordings, and wherein the first and second portions are selected from the available data according to user's viewing habits and video rental statistics as reported by the at least one STB.

14. A method of achieving real time video on demand using Tempo-Differential file transferring, comprising:
receiving a request from a user to view a video;
determining if the requested video is stored on the user's set top box (STB) memory;
initiating a download of the requested video to the user's STB memory if the requested video is not stored in the user's STB;
prompting the user to input or confirm user information using the STB as an input device and a video screen as an output device, wherein the time used to input or confirm user information comprises a first period of time;
displaying initial information on the video screen for a second period of time;
at least partially buffering the requested video in the user's STB memory during the first and second prescribed periods of time; and
displaying the selected video on the video screen while completing the download of the requested video.

15. The method of claim 14, wherein the initial information is selected from among video trailers, studio information, and an FBI warning screen.

16. The method of claim 15, wherein the central office is coupled to the user's STB with a Digital Subscriber Line (DSL).

17. The method of claim 16, wherein the DSL connection is one of ADSL, SDSL, or VDSL.

18. The method of claim 14, further comprising displaying a blank screen for a third period of time between segments of the initial information and between the prompting screen and the initial information displays.

19. The method of claim 14, wherein the requested video is downloaded from a central office memory.

20. A method of achieving real time video on demand (VOD), comprising:
populating a Central Office Storage Device with a first set of video recordings in accordance with an analysis of a plurality of user's viewing preferences;
populating a user's Set-Top-Box with a second set of video recordings in accordance with a profile of that user's preferences, the second set being a sub-set of the first set;
receiving a request from the user to view a video;
determining if the requested video is currently stored on the user's STB;
initiating a download of the requested video from the COS to the user's STB if the requested video is not currently stored in the user's STB;
prompting the user to input or confirm user information using the STB as an input device and a video screen as an output device, wherein the time used to input or confirm user information comprises a first period of time;
displaying initial information on the video screen for a second period of time;
at least partially buffering the requested video in the user's STB memory during the first and second prescribed periods of time;
displaying the selected video on the video screen while completing the download of the requested video; and
updating the user's preferences in accordance with the request to view a video.
